(19) United States
(12) Patent Application Publication
(10) Pub. No.: US 2023/0153499 A1
(43) Pub. Date: May 18, 2023

(54) Register-transfer level signal mapping construction method, device, apparatus and storage medium

(71) Applicant: Easy-Logic Technology (Shenzhen) Co., Ltd., Shenzhen City (CN)

(72) Inventors: Xing WEI, Shenzhen City (CN); Yi DIAO, Shenzhen City (CN); Tak Kei LAM, Shenzhen City (CN)

(21) Appl. No.: 17/955,901

(22) Filed: Sep. 29, 2022

(30) Foreign Application Priority Data
Nov. 13, 2021 (CN) 2021113435270

(51) Int. Cl. G06F 30/327; G06F 30/323; G06F 30/33

(52) U.S. Cl. CPC G06F 30/327; G06F 30/323; G06F 30/33

(57) ABSTRACT

A register-transfer level signal mapping construction method and device, wherein the register-transfer level signal mapping construction method comprises: acquiring register-transfer level codes and netlist level codes corresponding to the register-transfer level codes; constructing a circuit according to the register-transfer level codes and the netlist level codes; separating the circuit into a plurality of modules according to syntax of the circuit in a hardware description language; determining a correspondence relationship between the plurality of modules with logic verification methods; acquiring register-transfer level signals of a mapping relationship to be established; and determining netlist level signals corresponding to the register-transfer level codes according to the correspondence relationship between the plurality of modules. A mapping relationship between signals in the register-transfer level signals and signals in the netlist level codes is directly established, which can be implemented easily and done at low cost, and modification of the chip after logic synthesis is convenient.

### TECHNICAL FIELD

The present invention relates to the technical field of chip design and manufacturing, and especially to a register-transfer level signal mapping construction method, device, apparatus and storage medium.

### BACKGROUND TECHNOLOGY

In chip design processes, circuit logics are represented by codes, design engineers shall write register-transfer level codes according to design specifications, however, during tape-out, the register-transfer level codes shall be converted into netlist level codes. Conversion from register-transfer level codes to be netlist level codes is called logic synthesis. Logic synthesis can not only convert register-transfer level codes to be netlists, in the meanwhile, the netlist codes after conversion can also be optimized, thus logic synthesis plays a vital role in chip design.

However, in later stages of chip design, after conclusion of logic synthesis, it becomes troublesome to amend logic functions of chips, that is, to amend the register-transfer level codes or find corresponding signals of register-transfer level signals in the netlist level signals. Only the netlist level codes are used during chip tape-out, in the prior art, there are two methods to modify the register-transfer level codes, first, to redo logic synthesis, and second to modify manually the netlist level codes.

Both redoing logic synthesis and modifying manually the netlist level codes take long time, much money and manpower, and are of poor versatility and efficiency, and consequently the marketing period of the chips is significantly prolonged.

### SUMMARY OF THE INVENTION

Based on this, it is necessary to provide a register-transfer level signal mapping construction method, apparatus, device and storage medium targeting at the foregoing problems.

Embodiments of the present invention are realized in this way: a register-transfer level signal mapping construction method, wherein the method comprising:

Acquiring register-transfer level codes and netlist level codes corresponding to the register-transfer level codes;

Constructing a circuit based on the register-transfer level codes and the netlist level codes;

Separating the circuit into a plurality of modules depending on syntax of a hardware description language;

Determining a correspondence relationship between the plurality of modules with logical verification methods;

Acquiring register-transfer signals of a mapping relationship to be constructed;

Determining netlist level signals corresponding to the register-transfer level signals according to the correspondence relationship between the plurality of modules.

In one of the embodiments, the present invention provides a register-transfer level signal mapping construction device, wherein the device comprises:

A first acquisition module, configured to acquire register-transfer level codes and netlist codes corresponding to the register-transfer level codes;

A construction module, configured to construct a circuit based on the register-transfer level codes and the netlist level codes;

A separation module, configured to separate the circuit into a plurality of modules according to syntax of a hardware description language;

A logic verification module, configured to determine a correspondence relationship between the plurality of modules with logic verification methods;

A second acquisition module, configured to acquire register-transfer level signals of a mapping relationship to be constructed;

A correspondence module, configured to determine netlist level signals corresponding to register-transfer level signals according to the correspondence relationship between the plurality of modules.

In one of the embodiments, the present invention provides a computer device, comprising a storage device and a processor, wherein a computer program is stored in the storage device, and the computer program when executed by the processor will have the processor execute steps of the register-transfer level signal mapping construction method.

In one of the embodiments, the present invention provides a computer readable storage medium, wherein a computer program is stored on the computer readable storage medium, wherein the computer program when executed by a processor will have the processor execute steps of the register-transfer level signal mapping construction method.

In the present invention, a mapping relationship is established directly between the register-transfer level signals and the netlist level signals, without requiring manual modifications which consumes much manpower and the method is versatile; and compared with redoing logic synthesis, the duration is short, the cost is low, the realization method is simple, and the method is applicable for modification of logic functions after logic synthesis.

### BRIEF DESCRIPTION OF DRAWINGS

FIG. 1 is a flowchart diagram showing the register-transfer level signal mapping construction method provided in an embodiment of the present invention;

FIG. 2 is a flowchart diagram showing how to construct a circuit according to the register-transfer level codes and the netlist level codes in FIG. 1;

FIG. 3 is a flowchart diagram showing how to determine the correspondence relationship between the plurality of modules by logic verification methods in FIG. 1;

FIG. 4 is a flowchart diagram showing further steps after determining the correspondence relationship between the plurality of modules in FIG. 1;

FIG. 5 is a structural flowchart diagram showing the register-transfer level signal mapping construction device provided in an embodiment of the present invention;

FIG. 6 is a structural diagram showing internal structures of the computer device according to an embodiment of the present invention.

### EMBODIMENTS

To make purposes, technical solutions and advantages of the present invention clearer, hereinafter the present invention will be further described in details in conjunction with accompanying drawings and embodiments. It shall be understood that, the embodiments given here are only intended to explain the present invention rather than restrict the present invention.

It shall be understood that the terms “first”, “second” are used in the present invention to describe all kinds of elements, but unless indicated otherwise, the elements are not limited by the terms. The terms are employed only to differentiate an element from another element. For example, without departing from the scope of the present invention, the first xx script can be called the second xx script and similarly the second xx script can be called the first xx script.

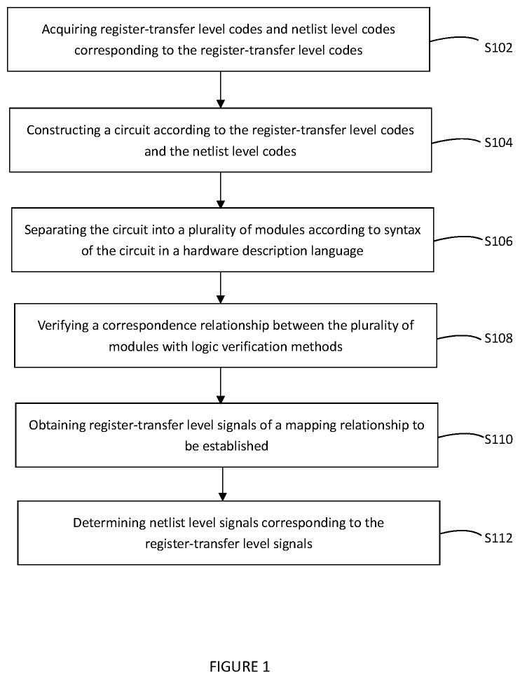

As shown in FIG. 1, in an embodiment, a register-transfer level signal mapping construction method is proposed, wherein the method comprises the following steps:

Step S102: acquiring register-transfer level codes and netlist level codes corresponding to the register-transfer level codes.

In an embodiment of the present invention, no limitation is given to acquisition methods of the register-transfer level codes and the netlist level codes, these codes are generated during chip design processes, algorithms provided in the present invention utilize these codes to establish a mapping relationship with the register-transfer level signals and no specific restriction is given to the codes themselves.

Step S104: construct a circuit according to the register-transfer level codes and the netlist level codes.

In an embodiment of the present invention, a chip circuit can be constructed by analyzing the codes, and it shall be noted that, to construct the circuit is not to establish a complete circuit, it may be just logic of the circuit and finally the entire circuit comprising several functional modules or logical modules is obtained, which is not equivalent to building a circuit diagram; obviously, by constructing the circuit diagram the problems in the present invention can also be addressed and better visual effects can be achieved and this is an optional solution.

Step S106, separate the circuit to be a plurality of modules according to syntax of the circuit in a hardware description language.

In an embodiment of the present invention, the circuit is expressed in a specific programming language, and depending on the language used, the circuit can be cut to be a plurality of functional modules or logical modules. In an embodiment of the present invention, each of the plurality of modules comprises at least an input end, at least an output end, at least an inout, at least a register unit, at least a combinational logical element and at least a sub-module, and there is a connection relationship among the units or the modules.

Step S108, determine a correspondence relationship between the plurality of modules with logical verification methods.

In an embodiment of the present invention, the correspondence relationship between the plurality of modules is determined by logical verification, specifically, third party tools such as SAT solver or simulation etc. can be used to this end, and in the present invention no specific limitation is given to this.

Step S110, acquire register-transfer level signals of the mapping relationship to be established.

Step S112, determine the netlist level signals corresponding to the register-transfer level signals according to the correspondence relationship between the plurality of modules.

In an embodiment of the present invention, after determining the correspondence relationship between the modules, a correspondence relationship between signals can be obtained by input and output of the signals.

In the present invention, a mapping relationship with the netlist level signals is directly established according to the signals in the register-transfer level signals, which does not require a large amount of manpower to modify the same, and is of good versatility; compared with redoing logic synthesis, the duration is short, the cost is low, the representation is simple and the method is suitable for modification of logical functions after logic synthesis of the chip.

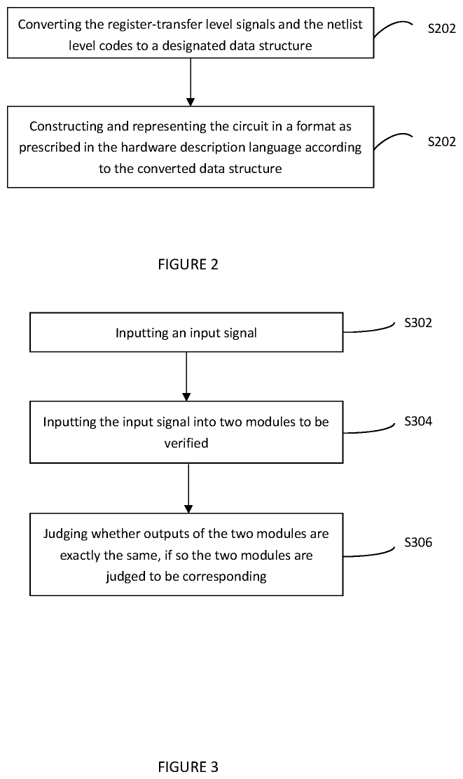

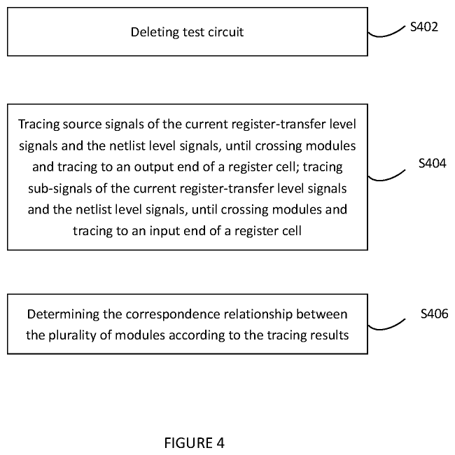

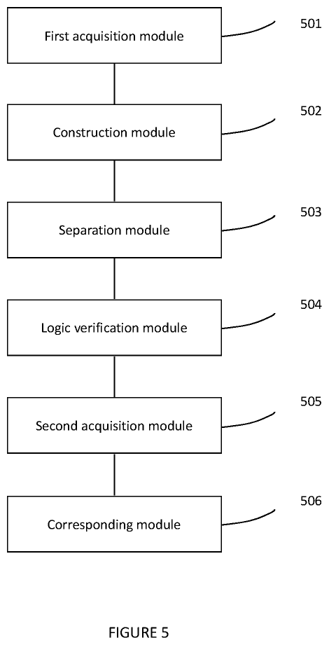

In an embodiment, as shown in FIG. 2, step S104 establishing the circuit according to the register-transfer level codes and the netlist level codes comprises specifically the following steps:

Step S202, converting the register-transfer level codes and the netlist level codes to be designated data structures.

In an embodiment of the present invention, after acquiring the register-transfer level codes and the netlist level codes, the codes are converted from string format to the designated data structures.

Step S204, constructing and representing the circuit in a format as stipulated by the hardware description language according to the data structures after conversion.

In an embodiment of the present invention, for explanation on the circuit please refer to the foregoing paragraphs.

In an embodiment, step S108 determining the correspondence relationship between the plurality of modules with the logic verification methods comprises specifically the following steps:

Step S302: determining an input signal.

Step S304: inputting the input signal respectively into the two modules to be verified.

In an embodiment of the present invention, compare whether the modules correspond to each other by inputting and outputting.

Step S306, judging whether outputs of the two modules are exactly the same, if they are exactly the same, the two modules correspond to each other.

In an embodiment, besides step S108 the method further comprises the following procedures:

Step S402, deleting a test circuit.

In an embodiment of the present invention, on the basis of logic verification, first of all, delete the test circuit, for example scan chain, and delete in the meanwhile corresponding information such as buffer tree.

Step S404, tracing source signals of current transfer-register level signals and netlist level signals according to logic relationships and connection relationships of the circuit, until crossing the modules and tracing to an output end of any register cell or an input end of any designated module; tracing subsignals of the current transfer-register level signals and the netlist level signals until crossing modules and tracing to an input end of a certain register cell or an output end of a designated module.

Step S406, determining a correspondence relationship between the plurality of modules according to the tracing results.

In an embodiment of the present invention, determining the correspondence relationship between the plurality of modules according to the tracing results comprises further the following steps: iterating each of the signals in each of the plurality of modules in the circuit, cross-verifying so as to determine the correspondence relationship between the plurality of modules.

In an embodiment, after step S406 the method further comprises: verifying the correspondence relationship between the plurality of modules with the logic verification methods.

In an embodiment of the present invention, after determining an output end and an input end corresponding to the register-transfer level signals and the netlist level signals, logic function comparison is done again by logic verification so as to realize the correspondence relationship between the transfer level signals and the netlist level signals and the output end and the input end.

As shown in FIG. 5, in an embodiment, a register-transfer level signal mapping construction device is provided and the device comprises specifically:

A first acquisition module 501, configured to acquire register-transfer level codes and netlist level codes corresponding to the register-transfer level codes;

A construction module 502, configured to construct a circuit based on the register-transfer level codes and the netlist level codes;

A separation module 503, configured to separate the circuit into a plurality of modules according to syntax of the circuit in a hardware description language;

A logic verification module 504, configured to determine a correspondence relationship between the plurality of modules with logic verification methods;

A second acquisition module 505, configured to acquire the register-transfer level signals to establish a mapping relationship;

A correspondence module 506, configured to determine the netlist level signals corresponding to the register-transfer level signals according to the correspondence relationship.

In an embodiment of the present invention, the foregoing modules correspond to the steps of the register-transfer level signal mapping construction method, and with regard to functional explanation of the modules, please find the explanation on the register-transfer level signal mapping construction method provided in an embodiment of the present invention, and the functional explanation of the modules will not be repeated here in the present embodiment.

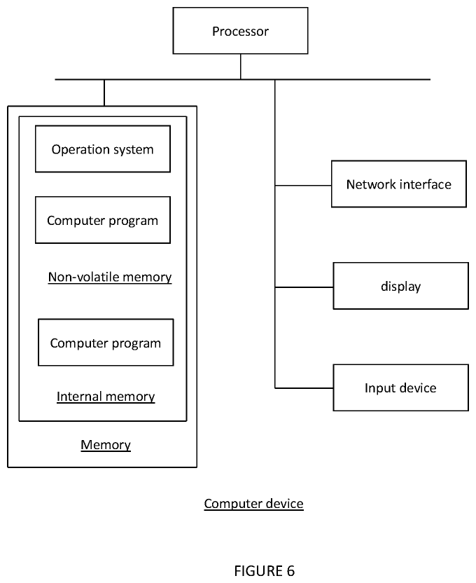

FIG. 6 is a diagram showing the internal structures of a computer device in an embodiment of the present invention. As shown in FIG. 6, the computer device comprises a processor, a storage device, a network interface, an input device and a display connected by system bus. Among them, the storage device comprises non-volatile storage medium and internal storage medium. An operating system is stored in the non-volatile storage medium, further a computer program is stored therein, and the computer program when executed by the processor will have the processor realize the register-transfer level signal mapping construction method as provided in embodiments of the present invention. The display of the computer device can be a liquid crystal display or an electronic ink display, the input device of the computer device can be a touch layer covered on the display, or keys, track balls or touch pads, and also can be externally connected keyboards, touch pads or mice.

Those skilled in the art can understand that, the structures shown in FIG. 6 show only some parts relevant to the technical solutions of the present invention, and don't constitute limitation on the computer device that the technical solutions of the present invention are applied on, specific computer devices can include more or less parts than those shown in the diagram, some parts can be combined or the parts can be configured in a different manner.

In an embodiment, the register-transfer level signal mapping construction device provided in an embodiment of the present invention can be realized in the form of a computer program, and the computer program can be run on a computer device as shown in FIG. 6. In the storage device of the computer device program modules that constitute the register-transfer level signal mapping construction device are stored.

In an embodiment, a computer device is proposed, wherein the computer device comprises a storage medium, a processor, and a computer program stored on the storage medium and can be run on the processor, the processor executes the computer program and realizes the following steps:

Acquiring register-transfer level codes and netlist level codes corresponding to the register-transfer level codes;

Constructing a circuit based on the register-transfer level codes and the netlist level codes;

Separating the circuit into a plurality of modules according to syntax of the circuit in hardware description languages;

Determining a correspondence relationship between the plurality of modules with logic verification methods;

Acquiring register-transfer level signals of a mapping relationship to be constructed;

Determining netlist level signals corresponding to register-transfer level signals based on the correspondence relationship between the plurality of modules.

It shall be understood that, although the steps in the flow process diagram of each of the embodiments of the present invention are shown stepwise according to indication of arrows, these steps are not necessarily executed sequentially as indicated by the arrows. Unless otherwise indicated expressly, there is no strict limitation on execution of the steps, and the steps can be implemented in other sequences. Furthermore, at least some of the steps of each of the embodiments can include a plurality of substeps or a plurality of stages, and these substeps or the stages are not necessarily executed and completed at the same moment and can be executed at different moments, execution orders of the substeps or the stages are not necessarily sequential, and can be executed alternately or in turn with other steps, substeps of other steps or at least part of a stage.

Those of ordinary skill in the art can understand that all or some of the processes in the foregoing embodiments can be realized by instructing corresponding hardware with a computer program, the program can be stored in a non-volatile computer readable storage medium, and the program when executed will execute the processes in the embodiments of the foregoing method. Above all, any citation in the embodiments of the present invention to the storage device, storage, databases or other media comprises non-volatile and/or volatile storage devices. Non-volatile storage devices comprise readable only memory (ROM), programmable ROM (PROM), electrically programmable ROM (EPROM), electrically erasable programmable ROM (EEPROM). Volatile storage media comprises random access memory (RAM) or external high speed cache memory. As explanation rather than limitation, RAM is obtainable in multiple forms, for example static RAM (SRAM), dynamic RAM (DRAM), synchronous RAM (SDRAM), double data rate SDRAM (DDRSDRAM), enhanced SDRAM (ESDRAM), synchronous link (Synchlink) DRAM (SLDRAM), memory bus (Rambus) direct RAM (RDRAM), direct Rambus dynamic RAM (DRDRAM) and Rambus dynamic RAM (RDRAM).

Technical features in the foregoing embodiments can be combined arbitrarily, and to simplify the description, not all possible combinations of the technical features in the foregoing embodiments have been described, however, as long as there is no conflict in combination of the technical features, the combinations shall be considered to fall into the protection scope of the present invention.

The foregoing embodiments show only several embodiments of the present invention, description of the embodiments is specific and detailed; however, the description shall not be construed as limitation to the scope of the present invention. It shall be noted that, for those of ordinary skill in the art, a plurality of variations and modifications can be made without departing from the spirit of the present invention, and all of these variations and modifications fall into the protection scope of the present invention. Therefore, the protection scope of the present invention shall be subject to the appended claims.

1. A register-transfer level signal mapping construction method, wherein the method comprising:
acquiring register-transfer level codes and netlist level codes corresponding to the register-transfer level codes;
constructing a circuit based on the register-transfer level codes and the netlist level codes;
separating the circuit into a plurality of modules depending on syntax of a hardware description language;
determining a correspondence relationship between the plurality of modules with logical verification methods;
acquiring register-transfer signals of a mapping relationship to be constructed;
determining netlist level signals corresponding to the register-transfer level signals according to the correspondence relationship between the plurality of modules.

2. The register-transfer level signal mapping construction method according to claim 1, wherein constructing the circuit based on the register-transfer level codes and the netlist level codes comprises:
converting the register-transfer level codes and the netlist level codes into designated data structures;
constructing and representing the circuit in a format as prescribed in the hardware description language according to the data structures after conversion.

3. The register-transfer level signal mapping construction method according to claim 1, wherein determining the correspondence relationship between the plurality of modules with the logic verification methods comprise:
inputting an input signal;
inputting the input signal respectively into two modules to be verified;
judging whether outputs of the two modules are exactly the same, if so the two modules are judged to be corresponding.

4. The register-transfer level signal mapping construction method according to claim 1, wherein determining the correspondence relationship between the plurality of modules with the logic verification methods comprises:
deleting a test circuit;
tracing source signals of the current register-transfer level signals and the netlist level signals according to a logic relationship and a connection relationship of the circuit, until crossing modules and tracing to an output end of a register cell or an input end of a designated module;
determining the correspondence relationship between the plurality of modules according to tracing results.

5. The register-transfer level signal mapping construction method according to claim 4, wherein the method further comprises:
verifying the correspondence relationship between the plurality of modules with the logic verification methods.

6. The register-transfer level signal mapping construction method according to claim 4, wherein after determining the correspondence relationship between the plurality of modules according to the tracing results the method further comprises:
iterating each signal in each of the plurality of modules, cross-checking and determining the correspondence relationship between the plurality of modules.

7. The register-transfer level signal mapping construction method according to claim 1, wherein the plurality of modules comprise at least an input end, at least an output end, at least an inout, at least a register cell, at least a combinational logic unit and at least a sub-module.

8. A register-transfer level signal mapping construction device, wherein the device comprises:
a first acquisition module, configured to acquire register-transfer level codes and netlist codes corresponding to the register-transfer level codes;
a construction module, configured to construct a circuit based on the register-transfer level codes and the netlist level codes;
a separation module, configured to separate the circuit into a plurality of modules according to syntax of a hardware description language;
a logic verification module, configured to determine a correspondence relationship between the plurality of modules with logic verification methods;
a second acquisition module, configured to acquire register-transfer level signals of a mapping relationship to be constructed;
a correspondence module, configured to determine the netlist level signals corresponding to the register-transfer level signals according to the correspondence relationship between the plurality of modules.

9. A computer device, comprising a storage device and a processor, wherein a computer program is stored in the storage device, and the computer program when executed by the processor will have the processor execute steps of the register-transfer level signal mapping construction method.
